(19) United States
(12) Patent Application Publication
(10) Pub. No.: US 2021/0321763 A1
(43) Pub. Date: Oct. 21, 2021

(54) RACK USED IN AUTOMATED STORAGE AND RETRIEVAL SYSTEM

(71) Applicants: HANGZHOU UNITED TOOLS CO., LTD., Hangzhou City (CN); HANGZHOU GREAT STAR INDUSTRIAL CO., LTD., Hangzhou City (CN)

(72) Inventor: Weiyi Wang, Hangzhou City (CN)

(21) Appl. No.: 16/346,452

(22) PCT Filed: Aug. 31, 2018
(86) PCT No.: PCT/CN2018/103623

§ 371 Date: Apr. 30, 2019

(51) Int. Cl. A47B 47/00; B65G 1/137; B65G 1/04

(52) U.S. Cl. CPC A47B 47/0058; B65G 1/137; B65G 2203/0216; B65G 1/0414; A47B 2230/0037; A47B 47/0083

(57) ABSTRACT

The present invention discloses a rack used in an automated storage and retrieval system, comprising uprights and one or more pallet bracket floors, wherein each pallet bracket floor comprises a pair of pallet beams; the pallet beam is detachably mounted on the upright and is set to be capable of allowing a pallet to be placed thereon; and a horizontal spacing between the pair of pallet beams is set to be capable of allowing a pallet fork of an automated guided vehicle to pass in a vertical direction.

### FIELD OF THE INVENTION

The present invention relates to a rack, and in particular to a rack used in an automated storage and retrieval system.

### DESCRIPTION OF THE PRIOR ART

In the modern storage and retrieval industry, an Automated Guided Vehicle (AGV) is used to transfer freight, to implement automated storage and retrieval. A rack, which is used as a storage unit of a storage and retrieval system, is generally used to store articles in a warehouse. By matching the rack with the AGV, a pallet can be picked up or put down conveniently and the space can be fully used.

A conventional rack is used to load relatively heavy articles, and therefore is generally a patchwork of horizontal braces, diagonal braces, and uprights. However, such a rack has a fixed floor height which cannot be adjusted; the matching pallet requires support feet for moving the pallet by means of the pallet fork of a forklift truck. Therefore, in the prior art, a rack that is more suitable for use with the AGV needs to be provided.

### SUMMARY OF THE INVENTION

In view of the above-mentioned defects of the prior art, the technical problem to be solved by the present invention is to provide a rack that is more suitable for use with the AGV.

In order to realize the above-mentioned purpose, the present invention first provides a rack used in an automated storage and retrieval system, comprising uprights and one or more pallet bracket floors. Each pallet bracket floor comprises a pair of pallet beams. The pallet beam is detachably mounted on the upright and is set to be capable of allowing a pallet to be placed thereon. A horizontal spacing between the pair of pallet beams is set to be capable of allowing a pallet fork of an automated guided vehicle to pass in a vertical direction.

In an embodiment, multiple location holes are provided on the upright. The pallet beam comprises a mounting surface and a supporting surface. A mounting hole that can match the location hole is provided on the mounting surface. Further comprises a connecting pin. The connecting pin is set to mount the pallet beam to the upright at a required height by means of the location hole and the mounting hole.

Further, a bottom of the upright is provided with a foot fixation surface and an anchor bolt provided on the foot fixation surface for fixing the upright on the ground.

In another aspect, the present invention further provides an automated storage and retrieval system, comprising a central control system, an automated guided vehicle, ground marks used to control a motion path of the automated guided vehicle, and multiple of racks used in the automated storage and retrieval system. The racks are arranged in rows. A spacing between the rows is set to be capable of allowing the automated guided vehicle to pass. Each rack and each pallet bracket have a code corresponding to a physical position thereof allocated by the central control system. The automated guided vehicle is set to be capable of receiving an instruction, which comprises the code, sent by the central control system, reach the rack corresponding to the code by means of the ground marks, and pick up or put down a pallet corresponding to the code by means of a lift platform and a pallet fork thereof.

The present invention further provides an automated storage and retrieval method, comprising the following steps:

(1) providing an automated storage and retrieval system as defined by claim 4;

(2) demounting and mounting the pallet beam to set a height of each pallet bracket floor, and inputting floor height information into the central control system; and

(3) sending, by the central control system, a code of a pallet bracket at a proper height to the automated guided vehicle according to a height of a freight object needing to be stored.

Compared with the prior art, in the present invention, the pallet fork of the AGV does not easily hit the rack when the AGV picks up or puts down the pallet. The beam can be rapidly demounted by being connected to the upright using the location pin, to adjust the floor height.

The concept, the specific structure and the produced technical effects of the present invention will be further described below with reference to the drawings, so as to fully understand the purposes, features and effects of the present invention.

### BRIEF DESCRIPTION OF THE DRAWINGS

FIG. 1 illustrates a rack according to one embodiment of the present invention.

FIG. 2 is a partial cross-sectional view of a rack beam according to one embodiment of the present invention.

FIG. 3 is an enlarged view of FIG. 2 according to one embodiment of the present invention.

FIG. 4 is a structural schematic view of a beam according to one embodiment of the present invention.

FIG. 5 is a structural schematic view of a connecting pin according to one embodiment of the present invention.

FIG. 6 is a structural schematic view of a pallet according to one embodiment of the present invention.

FIG. 7 illustrates an adjustment of a floor height of a rack according to one embodiment of the present invention.

FIG. 8 is a schematic view of an automated guided vehicle searching for a rack according to one embodiment of the present invention.

FIG. 9 is a schematic view of an automated guided vehicle picking up or putting down a rack according to one embodiment of the present invention.

FIG. 10 is a schematic view of an automated guided vehicle picking up or putting down a rack according to one embodiment of the present invention.

### DETAILED DESCRIPTION OF THE PREFERRED EMBODIMENTS

The present invention will be further described below with reference to the drawings in combination with the embodiments.

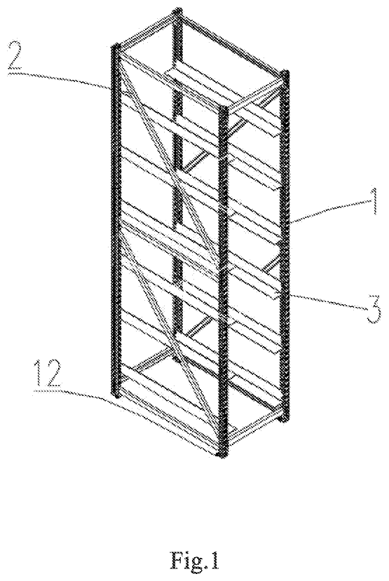

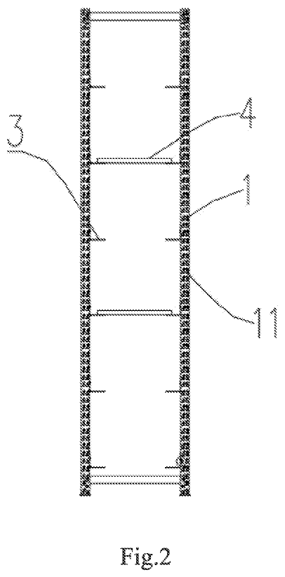

As shown in FIGS. 1, 2, and 6, a rack used in an automated storage and retrieval system according to one specific embodiment of the present invention comprises uprights 1 on which a connecting rod 2 and a pallet beam 3 are provided. Each pair of pallet beams form a pallet floor on which a pallet 4 can be placed. A freight object can be placed on the pallet. A horizontal spacing between the pallet beams 3 can allow a pallet fork of an automated guided vehicle to pass in a vertical direction. A bottom of the upright 1 is provided with a foot fixation surface 12. The upright 1 is fixed on the ground by means of an anchor bolt. A plurality of location holes 11 are further provided on the upright 1.

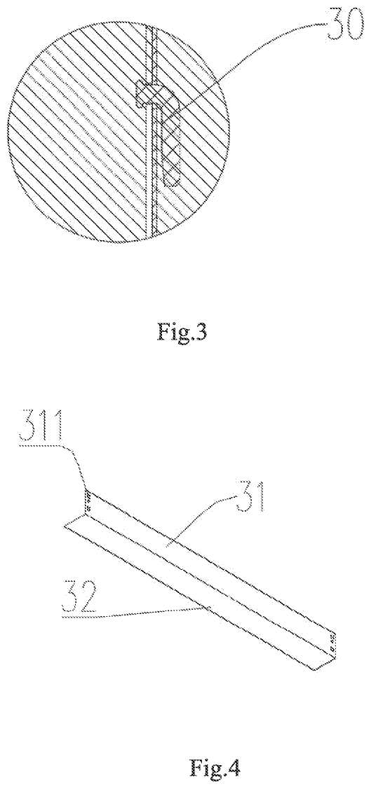

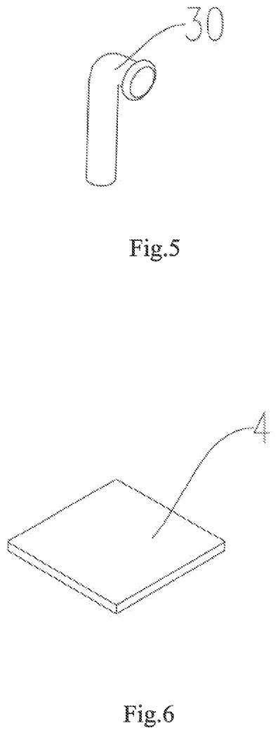

As shown in FIGS. 3, 4, and 5, the pallet beam 3 is provided with a mounting surface 31 and a supporting surface 32. A mounting hole 311 that can match the location hole 11 is provided on the mounting surface 31. A connecting pin 30 mounts the pallet beam 3 to the upright 1 by means of the location hole 11 and the mounting hole 311 as required.

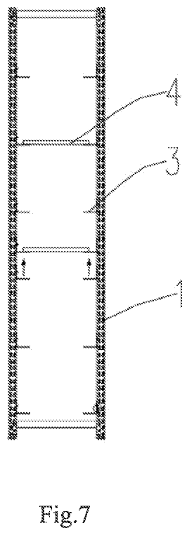

As shown in FIG. 7, when there is a need to adjust a floor height of the pallet floor, the connecting pin 30 is removed, another location hole 11 is selected, and the pallet beam 3 is remounted on the upright 1.

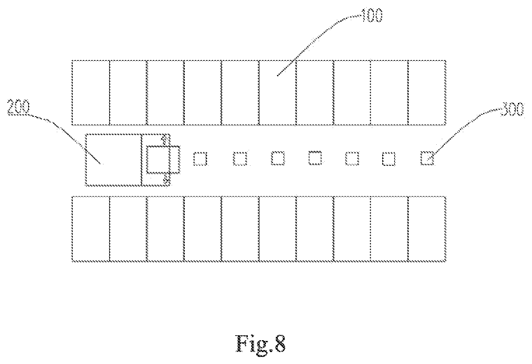

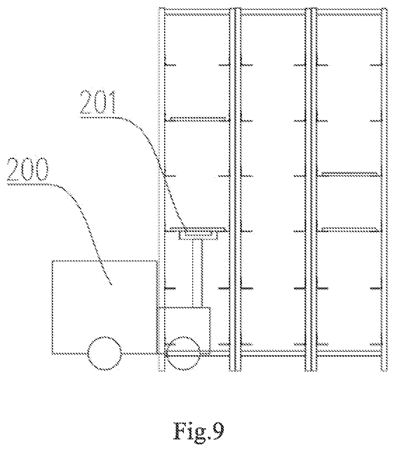

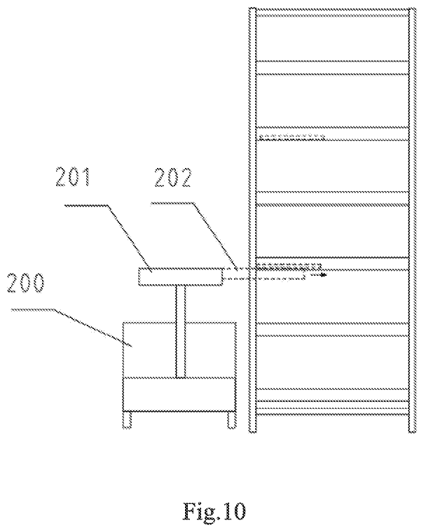

FIGS. 8, 9, and 10 illustrate an automated storage and retrieval system using the rack in the above-described embodiments. The system comprises multiple rows of such racks 100. A passage between the rows can allow an automated guided vehicle 200 to pass. Marks 300 are provided on the ground of the passage. The system further comprises a central control system which is not shown. The central control system allocates, to each rack and each pallet floor on the rack, a code corresponding to a physical position of the rack and the pallet floor. The automated guided vehicle 200 can reach a storage position of a designated freight object under the guidance of the ground marks according to the code. The automated guided vehicle 200 is provided with a lift platform 201 and a horizontally movable pallet fork 202. When a freight object needs to be picked up or put down, the central control system sends an instruction, which comprises a code, to the automated guided vehicle 200. The automated guided vehicle can find a rack 100 corresponding to the code according to the code, then lifts the lift platform 201 to a pallet floor corresponding to the code, and picks up or puts down the freight object by means of the pallet fork 202.

Further, because the floor height of the pallet floor of the rack according to the present invention is adjustable, different pallet floors can have different floor heights, to satisfy needs for storing freight objects of different heights. Floor height data can be inputted into the central control system. The central control system can designate a pallet floor satisfying a floor height requirement to the automated guided vehicle according to a height of a specific freight object.

The preferred specific embodiments of the present invention are described above. It should be understood that one skilled in the art could make various modifications and variations according to the concept of the present invention without contributing any inventive labor. Therefore, any technical solution that could be obtained by one skilled in the art according to the concept of the present invention on the basis of the prior art through logical analysis, reasoning or limited experiments shall be included in the protection scope determined by the claims.

1. A rack used in an automated storage and retrieval system, comprising uprights and one or more pallet bracket floors, wherein each pallet bracket floor comprises a pair of pallet beams, the pallet beam is detachably mounted on the upright and is set to be capable of allowing a pallet to be placed thereon, and a horizontal spacing between the pair of pallet beams is set to be capable of allowing a pallet fork of an automated guided vehicle to pass in a vertical direction.

2. The rack used in an automated storage and retrieval system according to Claim 1, wherein multiple location holes are provided on the upright; the pallet beam comprises a mounting surface and a supporting surface; a mounting hole that can match the location hole is provided on the mounting surface; and further comprises a connecting pin; the connecting pin is set to mount the pallet beam to the upright at a required height by means of the location hole and the mounting hole.

3. The rack used in an automated storage and retrieval system according to claim 2, wherein a bottom of the upright is provided with a foot fixation surface and an anchor bolt provided on the foot fixation surface for fixing the upright on the ground.

4. An automated storage and retrieval system, comprising a central control system, an automated guided vehicle, ground marks used to control a motion path of the automated guided vehicle, and multiple racks used in an automated storage and retrieval system according to claim 1, wherein the racks are arranged in rows; a spacing between the rows is set to be capable of allowing the automated guided vehicle to pass; each rack and each pallet bracket have a code corresponding to a physical position of the rack and the pallet bracket allocated by the central control system; the automated guided vehicle is set to be capable of receiving an instruction, which comprises the code, sent by the central control system, reach the rack corresponding to the code by means of the ground marks, and pick up or put down a pallet corresponding to the code by means of a lift platform and a pallet fork of the automated guided vehicle.

5. An automated storage and retrieval method, comprising the following steps:
(1) providing an automated storage and retrieval system according to claim 4;
(2) demounting and mounting a pallet beam to set a height of each pallet bracket floor, and inputting floor height information into a central control system; and
(3) sending, by the central control system, a code of a pallet bracket of a proper height to an automated guided vehicle according to a height of a freight object needing to be stored.

6. The automated storage and retrieval system according to claim 4, wherein multiple location holes are provided on the upright; the pallet beam comprises a mounting surface and a supporting surface; a mounting hole that can match the location hole is provided on the mounting surface; and further comprises a connecting pin; the connecting pin is set to mount the pallet beam to the upright at a required height by means of the location hole and the mounting hole.

7. The automated storage and retrieval system according to claim 6, wherein a bottom of the upright is provided with a foot fixation surface and an anchor bolt provided on the foot fixation surface for fixing the upright on the ground.

8. The automated storage and retrieval method according to claim 5, wherein multiple location holes are provided on the upright; the pallet beam comprises a mounting surface and a supporting surface; a mounting hole that can match the location hole is provided mount the pallet beam to the upright at a required height by means of the location hole and the mounting hole.

9. The automated storage and retrieval method according to claim 8, wherein a bottom of the upright is provided with a foot fixation surface and an anchor bolt provided on the foot fixation surface for fixing the upright on the ground.
